(19) United States
(12) Patent Application Publication
(10) Pub. No.: US 2017/0165582 A1
(43) Pub. Date: Jun. 15, 2017

(54) Fantasy Sports Game Managing Apparatus Reflecting Result of Real-Time Sports Event

(71) Applicants: Rankingball, Inc., Santa Clara, CA (US); Streetlab, Inc., Seoul (KR)

(72) Inventors: Young Hoon Kim, Gyeonggi-do (KR); Yong-Hyuk Chang, Gyeonggi-do (KR)

(21) Appl. No.: 15/377,513

(22) Filed: Dec. 13, 2016

Related U.S. Application Data
(60) Provisional application No. 62/266,998, filed on Dec. 14, 2015.

(51) Int. Cl. A63F 13/828; A63F 13/58; A63F 13/35

(52) U.S. Cl. CPC A63F 13/828; A63F 13/35; A63F 13/58

(57) ABSTRACT

A fantasy sports game managing apparatus includes a data processing and operation processing units. The operation processing unit stores pieces of daily fantasy sports game participation information including a game event selected by each of a plurality of users, a type of contest, a roster created by a user, and whether to use a player card, obtains game integration information included in sports game information from the data processing unit, and calculates a fantasy point of a lineup included in the roster of each user. When a player card is used in creating a roster, the operation processing unit calculates an additional point corresponding to performance of an athlete corresponding to the used player card according to a skill set included in the used player card, and adds up the calculated fantasy point and the additional point to determine a ranking of a contest according to the added fantasy point.

### TECHNICAL FIELD

The present invention relates to a fantasy sports game managing apparatus, and more particularly, to a fantasy sports game managing apparatus reflecting a result of a real-time sports event, capable of providing forecasts on sports and an interest in watching sports to a user by reflecting a result of a real-time sports event in which a user participates, in an operation of a fantasy game.

### BACKGROUND

A fantasy sports game proceeds such that a game user, as an owner, manages a virtual sports club generated on the basis of an actual sports club. Here, the fantasy sports game allows a game user to manage a team member in a manner of removing an existing player or scouting a new player or open a new league to perform a virtual game and manage results of a team, thus arousing users interest as if he manages an actual specific club.

Korean Patent Laid-Open Publication No. 10-2008-000403 relates to a method for providing a fantasy game using ARS. In detail, the method for providing a fantasy game using ARS includes: a step (a) in which when a user is connected to a game server providing a user participation service regarding a fantasy game through a phone, the game server provides a guide announcement required for participating in the fantasy game to the phone by ARS; a step (b) in which when the user inputs an option regarding organization of a team by operating the phone, the game server receives the option and organizes a team corresponding to the user; a step (c) in which the game server calculates results of the team by reflecting records generated in an offline actual play after step (b) in the team organized in step (b) according to predetermined regulations; and (d) the game server provides the results to the user, whereby results of the team organized by the game user on the basis of the actual offline records.

Conventional approaches provide a general fantasy game allowing a virtual sports club to be generated on the basis of an actual sports club and evaluating results of players organized by the user by utilizing actual offline results.

Also, in the case of a daily fantasy sports game evolved from a seasonal fantasy game, a salary cap is applied almost equally in most cases, and players are scouted within a salary-limited budget. A famous player may have too high salary to be scouted and a rookie may have a low salary but his record or ability may not be widely known so he may not obtain a point in many cases.

Professionals increase a winning rate through a scientific analysis, and those (amateurs) who challenge the thorough analysis of professionals by “intuition” are almost defeated. Competitions between professionals and amateurs under the same conditions without consideration of a difference in abilities therebetween make games unfair. This situation is confirmed in that, during the first half year of the major league baseball (MLB) in 2015, 91% of profits in daily fantasy sports (DFS) was obtained by 1.3% of the entire participants (professionals +amateurs) (McKinsey Report 2015). In this sense, property damage, a negative function, is considered to overtake an interest of sports, a positive function of the DFS.

Also, in most DFS, several live games are lumped to a single contest to proceed, and a configuration of a roster is finished before a first of the live games included in the contest starts, and after a final game of the contest is finished, a winner is determined by ranking fantasy points obtained by a roster created by a user through a final settlement. Thus, the DFS is unrelated to a real-time game and does not play an auxiliary role in watching a game in real time.

Also, while most of the participants of the DFS are viewers who enjoy watching sports, the DFS intrinsically runs short of real-time characteristics, leading to a problem in that it is not available to be utilized as a second screen interacting with participants or viewers in a broadcasting station.

### SUMMARY

An object of the present invention is to provide a fantasy sports game managing apparatus reflecting a result of a real-time sports event, capable of providing additional information regarding a game to a real-time game viewer, while simultaneously analyzing a context of the game on the basis of real-time game data to allow users to forecast a result at every major moment of the game, and providing a game point or game money according to the results.

Another object of the present invention is to provide a fantasy sports game managing apparatus reflecting a result of a real-time sports event, capable of registering a trigger point in a specific game situation with respect to game data input in real-time during a real-time game, transmitting real-time sports event data such as previously registered quiz, survey, and the like, to a user, collecting selection results of the user regarding real-time sports event data and providing the collected selection results to a system (broadcasting system) through a network, and calling, by the broadcasting system, the selection results by video overlay equipment, rendering the same, and overlaying the same on a real-time relay broadcast screen.

Another object of the present invention is to provide a fantasy sports game managing apparatus reflecting a result of a real-time sports event, whereby, when an amateur, who makes an effort to upgrade a player card by obtaining game money through viewing of real-time game and participation of a sports event, participates in a daily fantasy sports (DFS) game, a service such as a salary discount, or the like, is provided according to scouting a corresponding player to allow the amateur to form an advantageous line-up through efforts, and in the case of a DFS in which a great number of people participate, a strategic line-up may be variously configured even under a condition of salary cap to increase a probability of win of a novice or an amateur,

Another object of the present invention is to provide a fantasy sports game managing apparatus reflecting a result of a real-time sports event, whereby, compared with a related art second screen application which merely provides information, connectivity is maintaining by continuously engaging a viewer (user) through a quiz or questionnaire, and additional game information based on real-time game data is provided to provide information which may not be seen or known from a TV broadcast screen to help interpret game contents,

According to an aspect of the present invention for achieving the above objects, there is provided a fantasy sports game managing apparatus reflecting a result of a real-time sports event, including: a data processing unit processing sports game information; and an operation processing unit performing at least one of a player card service, a fantasy sports game service, and a real-time sports event service, wherein the operation processing unit stores pieces of daily fantasy sports game participation information including a game event selected by each of a plurality of users, a type of contest, a roster created by a user, and whether to use a player card, obtains game integration information included in sports game information from the data processing unit, and calculates a fantasy point of a lineup included in the roster of each user, and when a player card is used in creating a roster, the operation processing unit calculates an additional point corresponding to performance of an athlete corresponding to the used player card according to a skill set included in the used player card, adds up the calculated fantasy point and the additional point to determine a ranking of a contest according to the added fantasy point.

The skill set may be given an additional point differentiated by situations and grades.

The operation processing unit may perform a real-time sports event service, and regarding a player card which has purchased or retained an outcome point obtained by a user according to a result of an action in the real-time sports event service, the operation processing unit may issue a new skill set or upgrade a retained skill set.

The data processing unit may receive sports game information from a data providing server, and when an event corresponding to a previously stored trigger event table is included in the received sports game information, the data processing unit may transmit a notification message regarding the included event information to the operation processing unit.

The operation processing unit may perform an action regarding a trigger event corresponding to the transmitted notification message to perform the real-time sports event service.

When the user retains a player card regarding a player intended to be scouted in creating the roster, the operation processing unit may discount a salary of the player intended to be scouted.

An existing fantasy sports game which is not related to a real-time game, and since an entry registration is finished immediately before a first game corresponding to a contest starts, a user is not able to participate in the real-time game in any events thereafter. In contrast, in the present invention, since the real-time game is not directly involved in a fantasy point, the user may obtain game money for purchasing a player card and a skill set advantageously allowing the user to participate in a fantasy game later, while viewing the real-time game, whereby the user may be induced to view the game in actuality.

Also, in the present invention, since a user is continuously engaged using an event (quiz, questionnaire, game, etc.), connectivity between the user and a game or broadcasting is maintained, and since additional game information based on real-time game data is provided, the user may check information that may not be viewed and known in a TV broadcasting screen, thus helping the user interpret game contents.

Also, since the related art daily fantasy sports game is based on skill and knowledge, it is unfair for a professional and an amateur to compete with each other and play together under the same conditions. However, in the present invention, through efforts to view a real-time game and participate in a real-time sports event to obtain game money to purchase a player card or upgrade a skill set, when the user participates in a daily fantasy sports game, advantages such as salary discount in accordance with scouting a desired athlete or obtaining an additional fantasy point using a skill set are provided so that even the amateur may form an advantageous line-up through the efforts. Also, in the case of a daily fantasy sports game in which a plurality of users are participate, a fixed salary cap may become flexible through such a method, obtaining an effect of increasing a probability of winning for a beginner or an amateur.

Those skilled in the art will recognize additional features and advantages upon reading the following detailed description, and upon viewing the accompanying drawings.

### BRIEF DESCRIPTION OF THE DRAWINGS

The elements of the drawings are not necessarily to scale relative to each other. Like reference numerals designate corresponding similar parts. The features of the various illustrated embodiments can be combined unless they exclude each other. Embodiments are depicted in the drawings and are detailed in the description which follows.

FIG. 1 is a block diagram illustrating a configuration of a network system in which a fantasy sports game managing method reflecting a result of a real-time sports event is performed in accordance with the present invention.

FIG. 2 is a view illustrating real-time sports game information and a user selection button displayed on a game client terminal of FIG. 1

### DETAILED DESCRIPTION

Hereinafter, embodiments of the present invention will be described in detail with reference to the accompanying drawings.

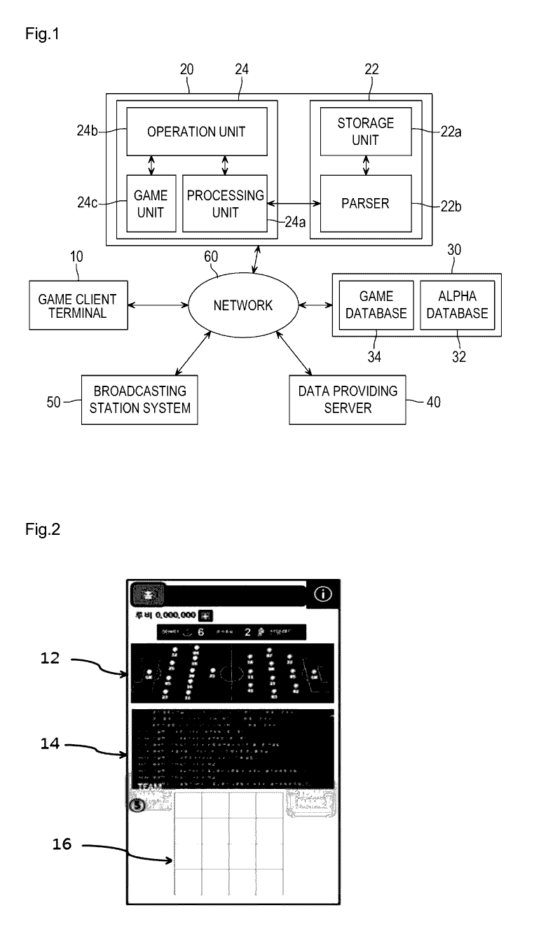

FIG. 1 is a block diagram illustrating a configuration of a network system in which a fantasy sports game managing method reflecting a result of a real-time sports event in accordance with the present invention.

An operation system includes a game client terminal 10 capable of performing communication such as a smartphone, a tablet, and the like, and connected to an operation server 20 by a user, the operation server 20 performing processing on sports game information, a player card service, a fantasy sports game service, and a real-time sports event service, a database system 30 including an alpha database 32 and a game database 34, a data providing server 40 providing information regarding a sports game, a broadcasting station system 50 managing cable broadcasting or terrestrial broadcasting, and a network 60 enabling data communication between the game client terminal 10, the operation server 20, the database system 30, the data providing server 40, and the broadcasting station system 50. Here, the broadcasting station system 50 and the network 60 have merely a technology level naturally understood by a person skilled in the art to which the present invention pertains, and thus, a detailed description thereof will be omitted. Also, the database system 30 and the operation server 20 may be implemented as a single device.

The game client terminal 10 is an information communication device having an input unit and a display unit, displaying data from the operation server 20, transmitting a user input or selection to the operation server 20 to allow the user to be provided with a player card service, a fantasy sports game service, and a real-time sports event service. The game client terminal 10 is connected to the operation server 20 through a dedicated application provided from the operation server 20 or a Web program such as an Internet explorer, or the like.

The data providing server 40 transmits sports game information in a raw or compressed form and in an XML format to the operation server 20 through the network 60.

Here, the sports game information includes league information of each sports, real-time game information, and additional information. The real-time game information includes team information (line-up, etc.), event information (in the case of soccer, a ball possession rate, an attack situation, centering, throw-in, offside, goal-in, valid shooting, over and under of score, a current status of game, a current status of scores of each team, and statistics of each team, and in the case of baseball, a current status of inning (on-base situation, ball count), a result of batter's box, replacement information, over/under of score, a current status of game, a current status of scores of each team, and statistics of each team), and a player name (a player related to an event may be displayed). Also, the additional information includes a record of a team, player information, and the like.

The data providing server 40 may provide sports game information in real-time, for a real-time sports event service. Here, the sports game information includes a current status of a game. Also, the data providing server 40 transmits a result of action of players in a game for a fantasy sports game service or sports game information as integrated game information integrally including a result of victory or defeat of a team to the operation server 20 in the middle of a game or at an end point of the game.

The operation server 20 includes a data processing unit 22 processing sports game information and an operation processing unit 24 performing a player card service using processed sports game information, a fantasy sports game service, and a real-time sports event service.

The data processing unit 22 includes a storage unit 22a decompressing compressed sports game information to convert the same into sports game information in a general XML form and storing the converted sports game information such that a parser 22b interprets the sports game information in the XML form transmitted from the data providing server 40, and applying the converted sports game information to the parser 22b, and the parser 22b reading and classifying the sports game information applied from the storage unit 22a, transferring the classified sports game information to the alpha database 32 to store the information therein.

When an event corresponding to a previously stored trigger event table is included in the sports game information, the parser 22b transmits or transfers a notification message (event-id) regarding included event information (type of trigger event) to a processing unit 24a of the operation processing unit 24. Table 1 shows the trigger event table.

TABLE 1

| Sports type | Soccer | Baseball |
|---|---|---|
| Type of trigger | Valid shooting, goal, | Single, double, appearance |
| event | penalty kick, corner kick, | of specific player, detailed |
| | foul, member change, etc. | result of specific player, |
| | | score of team, etc. |

The operation processing unit 24 includes the processing unit 24a receiving a notification message according to a type of a trigger event from the parser 22b, receiving sports game information from the alpha database 32 of the database system 30, transmitting a notification message (event-id) to an operating unit 24b to allow an action regarding a trigger event corresponding to the notification message (event-id) to be made, an operating unit 24b receiving the notification message (event-id) from the processing unit 24a, determining an action corresponding to the notification message (event-id), and transmitting a corresponding determination to a game unit 24c, and the game unit 24c performing an action according to the corresponding determination.

First, the processing unit 24a receives sports game information from the alpha database 32 in relation to a real time sports event service, and transmits the received sports game information to the game client terminal 10 through the network 60. Here, the sports game information includes game information received from the data providing server 40 or processed game information (e.g., OPS in the case of baseball, the number of valid shootings per played game of a player, etc.). Also, as the real-time sports event service is performed, when a user selection or input from the game unit 24c and an event of the notification message (event-id) are the same through the operating unit 24b, the processing unit 24a determines that the user has successfully forecasted, and when the user selection or input is not the same as the notification message (event-id), the processing unit 24a determines that the user has failed in forecasts. The processing unit 24a transmits the determination result to the game unit 24c such that it may be transmitted to the game client terminal 10. Also, the processing unit 24a accumulates an outcome point in accordance with successful forecasts in a user outcome point of a user account of the game database 34 of the database system 30 and stores the same in the game database 34. The processing unit 24a provides one or more of game money, an outcome point, and a skill set to the user according to a result (success/failure) of an action, and stores the same in the game database 34. When the outcome point is equal to or greater than a reference point, the outcome point is converted into game money and stored. Also, the skill set provides an additional point regarding a player card.

The operating unit 24b manages the operating server 20 and transmits a notification message (event-id) between the processing unit 24a and the game unit 24c and a user selection or input. The game unit 24c allows the user to access and participate in a player card service, a fantasy sports game service, and a real-time sports event service through the game client terminal 10. A process regarding these services will be described in detail hereinafter. Also, the game unit 24c takes an action corresponding to the notification message (event-id). The action includes a quiz (a question unrelated to a game situation or contents, etc.), an advertisement, a questionnaire (event forecasts), a game (a game unrelated to a game situation or contents), and the like.

The alpha database 32 of the database system 30 stores pure sports game information related to a game.

Also, the game database 34 of the database system 30 stores various types of information for performing services. Information related to a player card service includes a grade, a state, an attribute, an upgrade history, and the like, of a player card, information related to a real-time sports event service includes a participation record of a user, a wining record, a point, and the like, information related to the fantasy sports gate service includes a roster record, a type of contest, a result of contest, a point, contest-related information (a participant, an entry fee, a salary of each player, compensation, a start schedule, eta), and the like, and user-related data includes a user account, an access record, a retained game money, a participation record, and the like. The game database 34 may also store an operation-related log, data, and the like, such as a game score, a ranking, compensation, a quiz, and the like. Also, the player card information, the user account, and the retained game money corresponding to each user interwork with each other. The game money may separately purchased by the user.

The player card refers to a card regarding an athlete of each sports game, and includes a basic card provided by the game unit 24c and a purchase card that may be purchased by the user with game money. In purchasing a player card, a player card regarding a single player may be purchased and a player card pack including a plurality of players may be purchased. A level or a grade of the player card is increased by strengthening or evolving an animation character widely known in a game field.

Also, the game unit 24c analyzes a service usage form of the user, and when a specific condition (e.g., the number of times of accessing the operation server 20, etc.) is met, the game unit 24c may provide or distributes a certain player card to the user and stores the same in the game database 34. Also, the user may obtain a salary discount or an additional fantasy point allotted to a skill set with respect to a grade and a level of a player card (the same grade includes a plurality of levels). Raising a grade is called “progress”, and two highest level cards in which levels of the same grade is highest may be composed to be raised to a higher grade. Here, only a first player card (designated card) is raised, while a second player card (material card) becomes extinct. A level includes a plurality of stages in each grade, and raising a level is termed “strengthening”, and a card of a corresponding player is strengthened according to the number of times by which the card is participated in a fantasy contest.

Also, player card information includes a skill set related to each player card, and the skill set has a function of obtaining an additional point according to each situation. Table 2 shows examples of the skill set.

TABLE 2

| Skill | | | Additional |
|---|---|---|---|
| name | Situation | Grade | point |
| Goal | When an athlete scores a | 1 | 1 |
| | goal. | 2 | 2 |
| | | 3 | 3 |
| Assist | When an athlete creates an | 1 | 1 |
| | assist. | 2 | 2 |
| | | 3 | 3 |

The skill set interworks with each other regardless of a position of an athlete on a player card, and an additional point differentiated in each grade is give. The skill set may be a type of a trigger event in which a fantasy point is obtained from a fantasy game or a game result other than the type. For example, in the case of soccer, valid shooting, centering, and the like, may be a type of a trigger event, and a running time of a game, and the like, may be other than the type.

First, a real-time sports event service will be described. The processing unit 24a receives a notification message (event-id) from the parser 22b and transmits a notification message (event-id) to the operation unit 24b, and the operation unit 24b determines an action with reference to the trigger event table and the game unit 24c performs the action. As described above, the action is any one of a quiz, an advertisement, a questionnaire, and a game, and this embodiment will be described on the basis of a questionnaire.

For example, as for soccer, the game unit 24c performs a time attack questionnaire, and in the time attack questionnaire, when a wining goal is scored within a success reference time, starting from a point in time of a user selection regarding a time attack, it is determined as a success regarding the questionnaire. The time attack questionnaire may be started by an action based on a notification message (event-id) or the game unit 24c may independently start the time attack questionnaire, and the processing unit 24a obtains a start point of the time attack questionnaire from the game unit 24c. The game unit 24c causes a start of the time attack questionnaire to be displayed on the game client terminal 10, receives a user selection input from the game client terminal 10 in the course of the time attack questionnaire, and transmits the received user selection input to the processing unit 24a through the operation unit 24b.

The processing unit 24a includes a timer. After the start point of the time attack questionnaire, the processing unit 24a compares a time difference from a point in time at which a user selection is input to a point in time at which a notification message (event-id) indicating a goal is received with a success reference time (e.g., 5 minutes from a point in time at which the user selection is input). When the time difference is within the success reference time, the processing unit 24a determines that the user is successful, and when the time difference is not within the success reference time, the processing unit 24a determines that the user fails. The processing unit 24a stores an outcome point obtained by the user in the game database 34 according to a result of the action (questionnaire). Also, the processing unit 24a transmits the result of the action (questionnaire) to the game unit 24c through the operation unit 24b and the game unit 24c stores the result of the action (questionnaire) and transmits the result to the game client terminal 10 so that the user may check the result.

In the case of baseball, the game unit 24c may perform a questionnaire to forecast a result of a lineup of a specific player in response to a notification message (event-id). The questionnaire to forecast a result of a lineup is a questionnaire for forecasting a hitting result of a current specific player to hit the mark. In the questionnaire to forecast a result of a lineup, the user may select a single, a double, a triple, a homerun, strikeout, a ground ball out, and a fly out, for example. The game unit 24c receives a user selection (e.g., selection of a single) input from the game client terminal 10 and transmits the user selection input to the processing unit 24a through the operation unit 24b, and the processing unit 24a stores the user selection input. Thereafter, the parser 22b transmits a notification message (event-id) regarding a trigger event in a trigger event table to the processing unit 24a, and the processing unit 24a determines whether an event included in the notification message (event-id) and the user selection input are the same. When the event included in the notification message (event-id) and the user selection input are the same, that is, when both are the single, the processing unit 24a determines that the questionnaire is successful, or otherwise, the processing unit 24a determines that the questionnaire fails. The processing unit 24a stores an outcome point obtained by the user in the game database 34 according to a result of the action (questionnaire). Also, the processing unit 24a transmits the result of the action (questionnaire) to the game unit 24c through the operation unit 24b, and the game unit 24c stores the result of the action (questionnaire) and transmits the same to the game client terminal 10 so that the user may check it.

Also, the processing unit 24a accumulatively adds up outcome points obtained by the user, converts the accumulated outcome points into game money, issue a new skill set regarding a purchased player card or a retained player card, or updates a retained skill set, and stores the same in the game database 34. Upgrading the skill set includes adding a skill (skill name) included in the skill set.

Also, when the same trigger event occurs a plurality of times, the operation unit 24b may sequentially perform a quiz, an advertisement, and a questionnaire, or may repeatedly perform only the questionnaire.

Also, the database system 30 may transmit sports game information stored in the alpha database 32 to the game client terminal 10 through the network 60 so that the user may check the sport game information in real-time.

Also, in the course of performing a real time sports event service in real-time, the processing unit 24a may transmit action information to the broadcasting station system 50 so that an ongoing action may be displayed through cable broadcasting installed in a household, or the like, as well as on a display unit of the game client terminal 10, and the broadcasting station system 50 may display the action together in a game relay screen of cable broadcasting using video overlay equipment (not shown). Also, the processing unit 24a may provide a result of the received user selection input or statistical data to the broadcasting station system 50 so as to be displayed.

Also, the game unit 24c may rebroadcast a game in real-time to the game client terminal 10 using real time sports game information, and such real-time game rebroadcasting is synchronized with game rebroadcasting and data in cable broadcasting substantially in real-time. Thus, the broadcasting station system 50 may generate various types of interactions during an advertisement time of cable broadcasting.

A daily fantasy sports game service, among fantasy sports games, may be provided.

The game unit 24c provides a user interlace to the game client terminal 10 to allow the user to select a game event and a type of contest.

First, when the user selects a game event and a type of contest (game selection), the game unit 24c may allow the user to create a roster participating in a game through the game client terminal 10. The game unit 24c allows the user to scout players within a preset salary cap and create a roster. Also, the game unit 24c may allow the user to participate in a plurality of contests.

Here, in a case in which a player card regarding a player the user wants to scout in creating a roster is stored in the game database 34, that is, in a case in which the user retains a player card, the following benefits are provided.
1) Player salary discount function—In a case in which a retained player card has a grade equal to or higher than a reference grade, a player to be scouted may be scouted at low costs by discounting a salary of the player.
2) Additional point allocation function—in a case in which an additional point has been allotted to a skill set connected to a player card, when an action (e.g., a single, a winning goal, etc.) corresponding to the skill set takes place, the additional point allotted to the corresponding skill set is added to the fantasy point.

Of course, using (applying) the retained player card in (to) the daily fantasy sports game service is based on a user selection. Also, the game unit 24c may limit such that only one player card is used in one contest.

The game unit 24c stores the roster based on player scouting within a salary cap transmitted from the game client terminal 10, and allows game money of the user to be used for payment and allows the user to participate in the daily fantasy sports game service. Game money paid by users are allocated to the user by rankings after the contest is terminated.

The game unit 24c transmits daily fantasy sports game participation information including a game event selected by the user, a type of contest, a roster, and whether a player card is used to the processing unit 24a through the operation unit 24b, and the processing unit 24a stores daily fantasy sports game participation information corresponding to each user.

After receiving a notification message (event-id) regarding game integration information after termination of a corresponding game from the parser 22b, the processing unit 24a obtains game integration information included in sports game information from the alpha database 32, calculates a fantasy point of a lineup included in the roster of each user, and adds up fantasy points based on the entire lineup. Here, in a case in which a player card to which a skill set is associated is not used, the related art method of calculating a fantasy point from a fantasy game may be applied as a method for calculating a fantasy point according to game integration information. The processing unit 24a stores the calculated fantasy point in the game database 34, determines a ranking within a selected contest with respect to the fantasy point of each user, distributes game money determined in the selected contest according to a raking of each user, adds up the distributed game money to game money of each user, and stores the added money in the game database 34. The processing unit 24a transmits a contest result including the ranking, the distributed game money, and the like, to the game client terminal 10 through the operation unit 24b and the game unit 24c so that the user may check it.

In a case in which a player card to which a skill set is associated is used in creating a roster, the processing unit 24a determines whether performance performed by an athlete corresponding to the used player card during a game has been registered in the skill set. If performance of the athlete has been registered in the skill set, the processing unit 24a calculates an additional point corresponding to the performance of the athlete according to the skill set and adds the additional point to a previously calculated fantasy point to determine a fantasy point.

The processing unit 24a compares the determined fantasy points of users, determines rankings in the corresponding contest, distributes game money to the users according to the determined rankings, adds the distributed game money to game money of each user, and stores the same in the game database 34. The processing unit 24a transmits the contest result including the rankings, the distributed game money, and the like, to the game client terminal 10 through the operation unit 24b and the game unit 24c so that each user may check it.

As described above, the user who retains a player card and has used it, may obtain an additional point through the skill set of the player card to increase the ranking, and in particular, users having the same lineup may be differentiated in the fantasy points by additional points.

FIG. 2 is a view illustrating real-time sports game information and a user selection button displayed on the game client terminal 10 of FIG. 1.

The picture information 12 is part in which positions of players and changes in the position corresponding to real-time sports game information, allowing a real-time game status to be viewed at a glance so that the user may recognize a flow of a game, even without viewing TV broadcasting and check a result of a real-time sports event/game of the present invention. Character information 14 provides information corresponding to a trigger event included in the real-time sports game information to the user. A user selection button 16 may be configured in the form of bingo, for example. The game client terminal 10 receives and displays data including conditions of games/teams/players in each of the cells of the bingo from the operation server 20, and when a corresponding condition is met during a game, the operation server 20 (operation processing unit 24) selects (daubs) a corresponding cell. When one line is continuously satisfied horizontally/vertically/diagonally, it becomes the bingo and the user may obtain additional game money. The operation server 20 may operate a real-time bingo game by first half/second half of the game, by quarters, or by innings, and accumulates and analyzes results of game/team/player and statistical data to determine whether conditions of each cell of the bingo are met. The bingo is automatically daubed by the operation server 20, excluding users intervention. The user previously selects conditions of each cell before the bingo starts through the user selection button 16, and the game client terminal 10 transmits the selected conditions to the operation server 20, and the operation server 20 stores the selected conditions. For example, in the case of baseball, when a specific striker is designated in a cell, a result of a batters box of a corresponding batter is selected from on-base/out. In the case of soccer, how many (over or under) shots on target a specific striker is able to perform in a first half when the bingo is operated may be designated. Also, for example, when there is a cell regarding a team or a game, how many errors of each team should be may be designated by the user in the case of soccer, and the user may designate over/under score of a first half in the case of a game. When the corresponding conditions is designated, the designated conditions is not allowed to be changed during a game, and only when the corresponding conditions is achieved in an actual game, a cell is daubed.

The present invention is not limited to the specific embodiments. Thus, it will be understood by those skilled in the art that a variety of modifications and variations may be made to the present invention without departing from the spirit or scope of the present invention defined in the appended claims.

What is claimed is:

1. A fantasy sports game managing apparatus reflecting a result of a real-time sports event, the apparatus comprising:
a data processing unit configured to process sports game information; and
an operation processing unit configured to perform at least one of a player card service, a fantasy sports game service, and a real-time sports event service,
wherein the operation processing unit is configured to store pieces of daily fantasy sports game participation information including a game event selected by each of a plurality of users, a type of contest, a roster created by a user, and whether to use a player card, obtain game integration information included in sports game information from the data processing unit, and calculate a fantasy point of a lineup included in the roster of each user, and when a player card is used in creating a roster, the operation processing unit is configured to calculate an additional point corresponding to performance of an athlete corresponding to the used player card according to a skill set included in the used player card, and add up the calculated fantasy point and the additional point to determine a ranking of a contest according to the added fantasy point.

2. The fantasy sports game managing apparatus of claim 1, wherein the skill set is given an additional point differentiated by situations and grades.

3. The fantasy sports game managing apparatus of claim 1, wherein the operation processing unit is configured to perform a real-time sports event service, and regarding a player card which has purchased or retained an outcome point obtained by a user according to a result of an action in the real-time sports event service, the operation processing unit is configured to issue a new skill set or upgrade a retained skill set.

4. The fantasy sports game managing apparatus of claim 3, wherein the data processing unit is configured to receive sports game information from a data providing server, and when an event corresponding to a previously stored trigger event table is included in the received sports game information, the data processing unit is configured to transmit a notification message regarding the included event information to the operation processing unit.

5. The fantasy sports game managing apparatus of claim 4, wherein the operation processing unit is configured to perform an action regarding a trigger event corresponding to the transmitted notification message to perform the real-time sports event service.

6. The fantasy sports game managing apparatus of claim 5, wherein the action includes a questionnaire.

7. The fantasy sports game managing apparatus of claim 1, wherein the operation processing unit is configured to provide a certain player card to a user according to a service usage form of the user.

8. The fantasy sports game managing apparatus of claim 1, wherein when the user retains a player card regarding a player intended to be scouted in creating the roster, the operation processing unit is configured to discount a salary of the player intended to be scouted.

9. The fantasy sports game managing apparatus of claim , wherein the real-time sports event is provided in the form of bingo.

10. A network system in which a fantasy sports game managing method reflecting a result of a real-time sports event is performed, the network system comprising:
a fantasy sports game managing apparatus reflecting a result of a real-time sports event, the apparatus comprising: a data processing unit configured to process sports game information; and an operation processing unit configured to perform at least one of a player card service, a fantasy sports game service, and a real-time sports event service, wherein the operation processing unit is configured to store pieces of daily fantasy sports game participation information including a game event selected by each of a plurality of users, a type of contest, a roster created by a user, and whether to use a player card, obtain game integration information included in sports game information from the data processing unit, and calculate a fantasy point of a lineup included in the roster of each user, and when a player card is used in creating a roster, the operation processing unit is configured to calculate an additional point corresponding to performance of an athlete corresponding to the used player card according to a skill set included in the used player card, and add up the calculated fantasy point and the additional point to determine a ranking of a contest according to the added fantasy point; and
a database system including an alpha database configured to store sports game information and a game database configured to store information related to a player card service, information related to a real-time sports event service, information related to a fantasy sports game service, and user-related data.

11. The network system of claim 10, wherein the data processing unit is configured to store sports game information transmitted from the data providing server in the alpha database.
